(19) United States
(12) Patent Application Publication
(10) Pub. No.: US 2025/0322807 A1
(43) Pub. Date: Oct. 16, 2025

(54) DISPLAY SYSTEM

(71) Applicant: Japan Display Inc., Tokyo (JP)

(72) Inventor: Daijiro TAKANO, Tokyo (JP)

(21) Appl. No.: 19/098,042

(22) Filed: Apr. 2, 2025

(30) Foreign Application Priority Data
Apr. 15, 2024 (JP) 2024-065591

(51) Int. Cl. G09G 3/36; G02F 1/1334; G02F 1/139

(52) U.S. Cl. CPC G09G 3/3648; G02F 1/1334; G02F 1/139; G09G 2320/0686; G09G 2340/0435

(57) ABSTRACT

A display system includes a display device including a display panel; and an imaging device configured to capture an image of an imaging region in which at least the display panel is located. A one-frame period during which an image for one frame is displayed on the display panel includes a plurality of sub-field periods in which different colors are displayed. The display device is configured to be capable of changing a frame rate.

### CROSS-REFERENCE TO RELATED APPLICATION

This application claims the benefit of priority from Japanese Patent Application No. 2024-065591 filed on Apr. 15, 2024, the entire contents of which are incorporated herein by reference.

### BACKGROUND

### 1. Technical Field

The present disclosure relates to a display system.

### 2. Description of the Related Art

Technologies to apply a transparent display as a background plate for portrait photography are conventionally known (for example, Japanese Patent Application Laid-open Publication No. 2021-048433).

As the transparent display, transmissive liquid crystal display devices are known that perform display output by emitting light from light emitters for different colors in a time-division manner. When photographing such a transparent display that performs the display output using what is called a field-sequential color (FSC) system, coloration may occur in images captured by a camera and displayed on the display, depending on the shutter speed of the camera.

For the foregoing reasons, there is a need for providing a display system capable of capturing images displayed on the display without coloration.

### SUMMARY

According to an aspect of the present disclosure, a display system includes a display device including a display panel; and an imaging device configured to capture an image of an imaging region in which at least the display panel is located. A one-frame period during which an image for one frame is displayed on the display panel includes a plurality of sub-field periods in which different colors are displayed. The display device is configured to be capable of changing a frame rate.

### BRIEF DESCRIPTION OF THE DRAWINGS

FIG. 1 is a diagram illustrating a schematic configuration of a display system according to a first embodiment of the present disclosure;

FIG. 2 is a schematic circuit diagram illustrating a main configuration of a display device;

FIG. 3 is a schematic sectional view of a display panel;

FIG. 4 is a timing diagram illustrating an exemplary one-frame period;

FIG. 5 is a diagram illustrating a first example of imaging timing in an imaging device and display timing in the display device;

FIG. 6 is a diagram illustrating a second example of the imaging timing in the imaging device and the display timing in the display device;

FIG. 7 is a first conceptual diagram illustrating a first specific example of frame rate change in the display device;

FIG. 8 is a second conceptual diagram illustrating the first specific example of the frame rate change in the display device;

FIG. 9A is a first conceptual diagram illustrating a second specific example of the frame rate change in the display device;

FIG. 9B is a second conceptual diagram illustrating the second specific example of the frame rate change in the display device;

FIG. 10 is a third conceptual diagram illustrating the second specific example of the frame rate change in the display device;

FIG. 11 is a diagram illustrating a third example of the imaging timing in the imaging device and the display timing in the display device;

FIG. 12 is a diagram illustrating a fourth example of the imaging timing in the imaging device and the display timing in the display device;

FIG. 13 is a diagram illustrating a schematic configuration of a display system according to a second embodiment of the present disclosure; and

FIG. 14 is a conceptual diagram illustrating a third specific example of the frame rate change in a display device.

### DETAILED DESCRIPTION

The following describes modes (embodiments) for carrying out the present disclosure in detail with reference to the drawings. The present disclosure is not limited to the description of the embodiments to be given below. Components to be described below include those easily conceivable by those skilled in the art or those substantially identical thereto. In addition, the components to be described below can be combined as appropriate. What is disclosed herein is merely an example, and the present disclosure naturally encompasses appropriate modifications easily conceivable by those skilled in the art while maintaining the gist of the disclosure. To further clarify the description, the drawings schematically illustrate, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

### First Embodiment

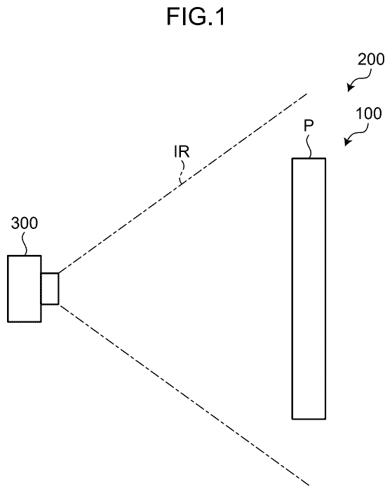

FIG. 1 is a diagram illustrating a schematic configuration of a display system according to a first embodiment of the present disclosure. As illustrated in FIG. 1, a display system 200 according to the first embodiment includes a display device 100 and an imaging device 300.

In the present disclosure, the display device 100 is a transmissive liquid crystal display device that performs display output using what is called a field-sequential color (FSC) system to control pixels so that light rays in a plurality of colors are transmitted through the same pixel at times different from one another.

In the present disclosure, the imaging device 300 is a camera that captures an image that includes at least a display panel P of the display device 100 within an imaging region IR. The imaging device 300 may be a still camera that captures what are called still images or a video camera that captures moving images. The imaging device 300 may be what is called a film camera that captures images by exposing a film coated with a photosensitive agent, or a digital camera that obtains images using an image sensor such as a charge-coupled device (CCD) or a complementary metal-oxide-semiconductor (CMOS).

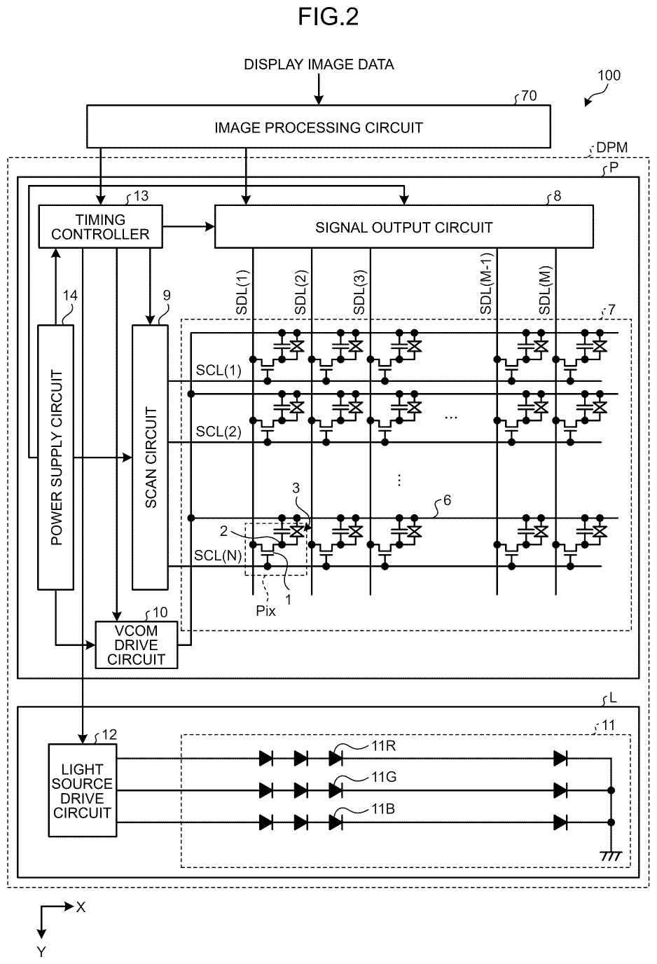

FIG. 2 is a schematic circuit diagram illustrating a main configuration of the display device. The display device 100 includes a display panel module DPM and an image processing circuit 70. The display panel module DPM includes the display panel P and a light source device L.

The display panel P includes a display area 7, a signal output circuit 8, a scan circuit 9, a VCOM drive circuit 10, a timing controller 13, and a power supply circuit 14. Hereafter, one surface of the display panel P faced by the display area 7 is referred to as a “display surface” and the other surface is referred to as a “back surface”. A lateral side of the display device 100 refers to a side located, with respect to the display device 100, in a direction intersecting (for example, orthogonal to) a direction in which the display surface and the back surface face each other.

A plurality of pixels Pix are arranged in a matrix having a row-column configuration in an X direction (first direction) and a Y direction (second direction) in the display area 7. The Y direction (second direction) is a direction intersecting the X direction (first direction). More specifically, in the example illustrated in FIG. 2, the Y direction (second direction) is a direction orthogonal to the X direction (first direction).

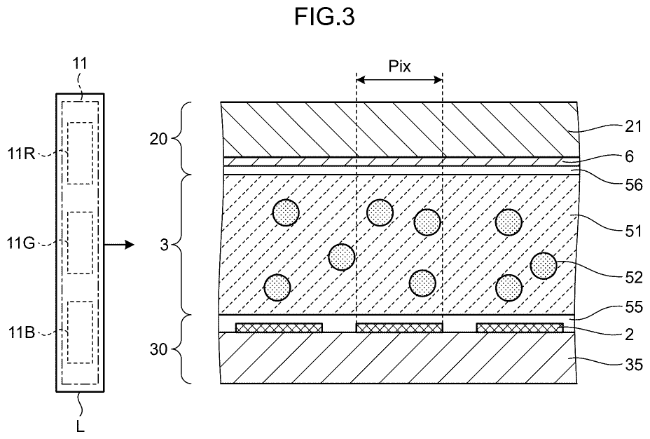

Each of the pixels Pix includes a switching element 1 and two electrodes. FIG. 3 is a schematic sectional view of the display panel. FIGS. 2 and 3 illustrate a pixel electrode 2 and a common electrode 6 as the two electrodes.

The display panel P includes two substrates facing each other and liquid crystals 3 enclosed between the two substrates. Hereinafter, one of the two substrates is referred to as a first substrate 30, and the other of them is referred to as a second substrate 20.

The first substrate 30 includes a light-transmitting glass substrate 35, the pixel electrode 2 stacked on the second substrate 20 side of the glass substrate 35, and an orientation film 55 stacked on the second substrate 20 side of the pixel electrode 2 so as to cover the pixel electrode 2. The pixel electrode 2 is individually provided for each of the pixels Pix. The second substrate 20 includes a light-transmitting glass substrate 21, the common electrode 6 stacked on the first substrate 30 side of the glass substrate 21, and an orientation film 56 stacked on the first substrate 30 side of the common electrode 6 so as to cover the common electrode 6. The common electrode 6 has a plate-like or film-like shape shared among the pixels Pix.

The liquid crystals 3 of the first embodiment are polymer-dispersed liquid crystals (PDLCs). In other words, in the present embodiment, the display panel P is a liquid crystal panel enclosing the polymer-dispersed liquid crystals. Specifically, the liquid crystals 3 contain a bulk 51 and fine particles 52. The fine particles 52 change in orientation in the bulk 51 in accordance with a potential difference between the pixel electrode 2 and the common electrode 6. The scattering state of the liquid crystals 3 is controlled for each of the pixels Pix by individually controlling the potential of the pixel electrode 2 for each of the pixels Pix.

FIG. 3 illustrates the example in which the pixel electrode 2 and the common electrode 6 are arranged so as to face each other with the liquid crystals 3 interposed therebetween. However, the display panel P may be configured such that the pixel electrode 2 and the common electrode 6 are provided on one substrate, and an electric field generated by the pixel electrode 2 and the common electrode 6 changes the orientation of the liquid crystals 3 and thus controls the scattering state of the liquid crystals 3.

The display device 100 according to the present disclosure is a transparent display device configured to control the potentials of the pixel electrode 2 and the common electrode 6 to allow an image transmitted through the display panel P to be viewed. The following describes a mechanism to control the potentials of the pixel electrode 2 and the common electrode 6.

The switching element 1 is a switching element using a semiconductor such as a thin-film transistor (TFT). One of the source and the drain of the switching element 1 is coupled to one of the two electrodes (pixel electrode 2). The other of the source and the drain of the switching element 1 is coupled to a signal line SDL(m) (m is an integer from 1 to M, where M is a total number of the signal lines). The gate of the switching element 1 is coupled to a scan line SCL(n) (n is an integer from 1 to N, where N is a total number of the scan lines). Under the control of the scan circuit 9, the scan line SCL(n) applies a potential to switch the open and closed states between the source and the drain of the switching element 1. The scan circuit 9 controls the potential.

In the example illustrated in FIG. 2, a plurality of the signal lines SDL(n) are arranged along one of the arrangement directions (row direction) of the pixels Pix. The signal line SDL(m) extends along the other of the arrangement directions (column direction) of the pixels Pix. The signal line SDL(m) is shared by the switching elements 1 of the pixels Pix arranged in the column direction. A plurality of the scan lines SCL(n) are arranged along the column direction. The scan line SCL(n) extends along the row direction. The scan line SCL(n) is shared by the switching elements 1 of the pixels Pix arranged in the row direction.

In the present disclosure, the X direction (first direction) refers to the direction in which the scan line SCL(n) extends, and the Y direction (second direction) refers to the direction in which the scan lines SCL(n) are arranged.

The common electrode 6 is coupled to the VCOM drive circuit 10. The VCOM drive circuit 10 applies a common potential to the common electrode 6.

The scan circuit 9 sequentially supplies a drive signal that serves as an on-potential (drive potential) of the switching elements 1 to the scan line SCL(n) coupled to the pixels Pix arranged in the X direction (first direction). In other words, the scan circuit 9 simultaneously supplies the drive signal to the pixels Pix arranged in the X direction (first direction). The scan circuit 9 sequentially supplies the drive signal to the pixels Pix arranged in the Y direction (second direction).

The signal output circuit 8 sequentially supplies a pixel signal that serves as data of a pixel corresponding to each of the pixels Pix (hereinafter, also referred to as “pixel data”) to the signal line SDL(m) coupled to the pixels Pix arranged in the Y direction (second direction). In other words, the signal output circuit 8 sequentially supplies the pixel data to the pixels Pix arranged in the Y direction (second direction). The signal output circuit 8 simultaneously supplies the pixel data to the pixels Pix arranged in the X direction (first direction).

When the scan circuit 9 supplies the drive signal to the scan line SCL(n) and the switching elements 1 of the pixels Pix arranged in the X direction (first direction) are controlled to be on, the signal output circuit 8 outputs the pixel signals to the signal lines SDL(m) to charge the liquid crystals 3 (fine particles 52) serving as a storage capacitor and a capacitive load generated between the pixel electrodes 2 of the pixels Pix arranged in the X direction (first direction) and the common electrode 6. As a result, a voltage corresponding to the pixel data corresponding to each of the pixels Pix arranged in the X direction (first direction) is applied between the pixel electrode 2 of the pixel Pix and the common electrode 6. The scan circuit 9 sequentially supplies the drive signals to the scan lines SCL(n) arranged in the Y direction (second direction), and the signal output circuit 8 supplies the pixel data corresponding to the pixels Pix coupled to the scan line SCL(n) supplied with the drive signal by the scan circuit 9. As a result, the pixel data of an image for one sub-field (each of a plurality of monochromatic images constituting an image for one frame) is written.

After the switching element 1 is turned off, the voltage applied between pixel electrode 2 and the common electrode 6 is held by the liquid crystals 3 (fine particles 52) serving as the storage capacitor and the capacitive load. The degree of scattering of the liquid crystals 3 (fine particles 52) is controlled according to the voltage applied between the pixel electrode 2 of each of the pixels Pix and the common electrode 6. The liquid crystals 3 may be, for example, polymer-dispersed liquid crystals that increase in degree of scattering with increase in the voltage applied between the pixel electrode 2 of each of the pixels Pix and the common electrode 6, or may be polymer-dispersed liquid crystals that increase in degree of scattering with decrease in the voltage applied between the pixel electrode 2 of each of the pixels Pix and the common electrode 6.

As illustrated in FIG. 3, the light source device L is located on a lateral side of the display panel P (lower side of the display panel P in FIG. 2). The light source device L includes a light source 11 that emits light to a side surface of the display panel P and a light source drive circuit 12 that controls the light source 11. The light source 11 includes a first light source 11R, a second light source 11G, and a third light source 11B.

The first light source 11R, the second light source 11G, and the third light source 11B each emit light under the control of the light source drive circuit 12. The first light source 11R, the second light source 11G, and the third light source 11B are light sources using light-emitting elements such as light-emitting diodes (LEDs), but are not limited to such light sources, and only need to be light sources controllable in light emission timing.

The light source drive circuit 12 controls the light emission timing of the first light source 11R, the second light source 11G, and the third light source 11B under the control of the timing controller 13. In the present disclosure, the emission color of the first light source 11R (first color) is red (R), the emission color of the second light source 11G (second color) is green (G), and the emission color of the third light source 11B (third color) is blue (B).

When the light is emitted from the light source 11, the display area 7 is irradiated by the light (first color, second color, and third color) emitted from one side surface side in the Y direction. Each of the pixels Pix transmits or scatters the light emitted from the one side surface side in the Y direction. The degree of scattering of the liquid crystals 3 for each of the pixels Pix depends on the state of the liquid crystals 3 controlled according to the pixel signal for each of the pixels Pix.

The timing controller 13 is a circuit that controls the operation timing of the signal output circuit 8, the scan circuit 9, the VCOM drive circuit 10, and the light source drive circuit 12. In the present disclosure, the timing controller 13 operates based on signals received via the image processing circuit 70.

The image processing circuit 70 outputs signals based on display image data to the signal output circuit 8 and the timing controller 13. When the pixel data is assumed to be data indicating red-green-blue (RGB) gradation values assigned to one of the pixels Pix provided in the display area 7, the display image data supplied to the image processing circuit 70 to output an image for display is a set of a plurality of pieces of the pixel data for the respective pixels Pix in the display area 7. The image processing circuit 70 may be provided on one of the substrates included in the display panel P, may be mounted on a flexible printed circuit board provided with, for example, wiring extending from the display panel P, or may be provided outside the display panel P.

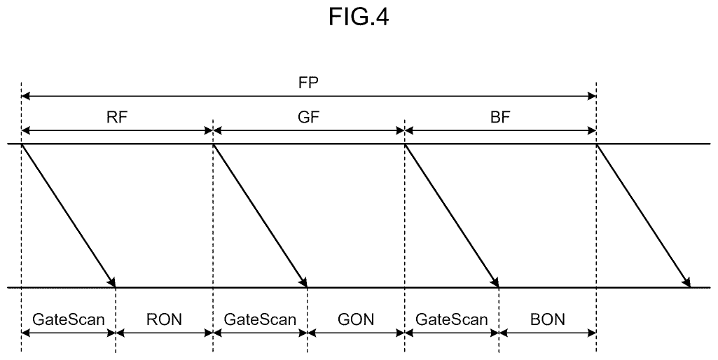

FIG. 4 is a timing diagram illustrating sub-field periods and light emission periods in a one-frame period during which the display image data is displayed.

In the display device 100 that performs the display output using the FSC system, an image display period FP for one frame based on the display image data is divided into a first sub-field period RF, a second sub-field period GF, and a third sub-field period BF, as illustrated in FIG. 4.

During a vertical scan period GateScan (first period) of the first sub-field period RF, the pixel data corresponding to an output gradation value of each of the pixels Pix corresponding to the first color (red (R)) of the display image data is written. As a result, a voltage corresponding to the pixel data for each of the pixels Pix is applied to the pixel electrode 2, and the scattering state of the liquid crystals 3 for each of the pixels Pix is controlled according to the voltage applied to the pixel electrode 2.

The first light source 11R emits light during a subsequent light emission period RON (second period). During this light emission period RON (second period), light in the first color (red (R)) corresponding to the pixel data for each of the pixels Pix written in the previous vertical scan period GateScan is scattered and displayed.

During the vertical scan period GateScan (first period) of the second sub-field period GF, the pixel data corresponding to an output gradation value of each of the pixels Pix corresponding to the second color (green (G)) of the display image data is written. As a result, a voltage corresponding to the pixel data for each of the pixels Pix is applied to the pixel electrode 2, and the scattering state of the liquid crystals 3 for each of the pixels Pix is controlled according to the voltage applied to the pixel electrode 2.

The second light source 11G emits light during a subsequent light emission period GON (second period). During this light emission period GON (second period), light in the second color (green (G)) corresponding to the pixel data for each of the pixels Pix written in the previous vertical scan period GateScan is scattered and displayed.

During the vertical scan period GateScan (first period) of the third sub-field period BF, the pixel data corresponding to an output gradation value of each of the pixels Pix corresponding to the third color (blue (B)) of the display image data is written. As a result, a voltage corresponding to the pixel data for each of the pixels Pix is applied to the pixel electrode 2, and the scattering state of the liquid crystals 3 for each of the pixels Pix is controlled according to the voltage applied to the pixel electrode 2.

The third light source 11B emits light during a subsequent light emission period BON (second period). During this light emission period BON (second period), light in the third color (blue (B)) corresponding to the pixel data for each of the pixels Pix written in the previous vertical scan period GateScan is scattered and displayed.

In the display device 100 of the FSC system described above, an image in which three colors of the first color (red (R)), the second color (green (G)), and the third color (blue (B)) are combined (mixed) is recognized due to an afterimage phenomenon caused by limited temporal resolution of a human eye. Since the display device 100 based on the FSC system does not require a color filter for each of the pixels Pix, light transmittance in the display area 7 can be made higher.

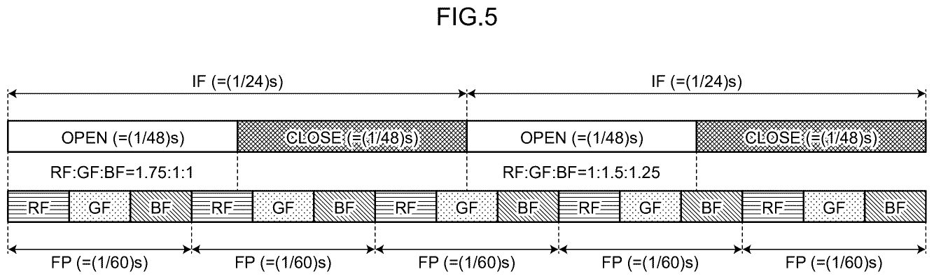

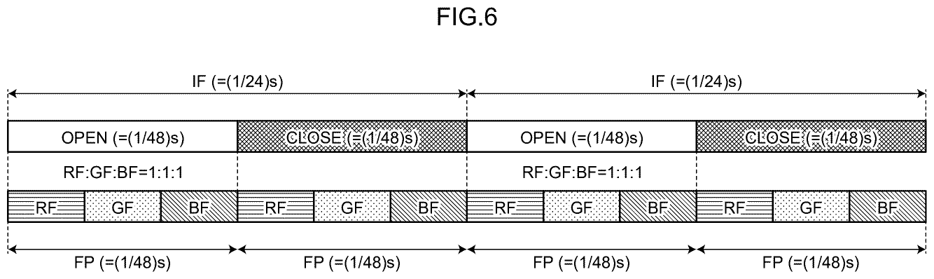

FIG. 5 is a diagram illustrating a first example of imaging timing in the imaging device and display timing in the display device. FIG. 6 is a diagram illustrating a second example of the imaging timing in the imaging device and the display timing in the display device. The examples are illustrated where a one-frame period IF for the imaging device 300 to capture the image for one frame is 1/24 s (in other words, the imaging frame rate of the imaging device 300 is 24 frames per second (fps)) and the shutter speed of the imaging device 300 is 1/48 s. The imaging frame rate of the imaging device 300 is not limited to 24 fps. The shutter speed of the imaging device 300 is not limited to 1/48 s.

The first example illustrated in FIG. 5 illustrates an example where the one-frame period FP for displaying the image for one frame on the display device 100 is 1/60 s (in other words, the display frame rate of the display device 100 is 60 fps). In this case, the balance among the sub-field periods RF, GF, and BF included in the period while the shutter of the imaging device 300 is open ( 1/48 s) is uneven (for example, RF:GF:BF=1.75:1:1 or RF:GF:BF=1:1.5:1.25 in the example illustrated in FIG. 5), and the display image of the display device 100 captured in each imaging frame of the imaging device 300 is colored.

The second example illustrated in FIG. 6 shows an example where the one frame period FP for displaying one frame of an image on the display device 100 is ( 1/48) s (in other words, the display frame rate on the display device 100 is 48 fps). In this case, the balance among the sub-field periods RF, GF, and BF included in the period while the shutter of the imaging device 300 is open ( 1/48 s) is not uneven (RF:GF:BF=1:1:1 as illustrated in FIG. 6), and the display image of the display device 100 captured in each imaging frame of the imaging device 300 is not colored.

The display system 200 according to the present disclosure is configured to be capable of changing the frame rate of the display device 100. The following describes specific examples of the frame rate change in the display device 100.

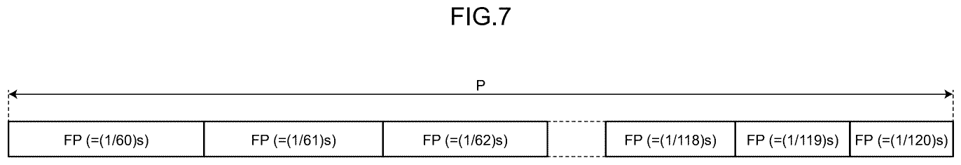

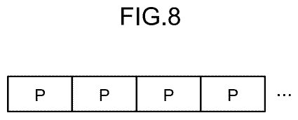

FIG. 7 is a first conceptual diagram illustrating a first specific example of the frame rate change in the display device. FIG. 8 is a second conceptual diagram illustrating the first specific example of the frame rate change in the display device.

In the first specific example illustrated in FIGS. 7 and 8, the display device 100 repeats a period P in which the display frame rate changes stepwise (for example, in steps of 1 fps) from a first frame rate (for example, 60 fps) to a second frame rate (for example, 120 fps). As a result, when the display frame rate is 96 fps, the balance among the sub-field periods RF, GF, and BF included in the period while the shutter of the imaging device 300 is open ( 1/48 s) does not become uneven, and the display image of the display device 100 captured in the imaging frame of the imaging device 300 is not colored. Thus, the display image of the display device 100 can be captured without coloration.

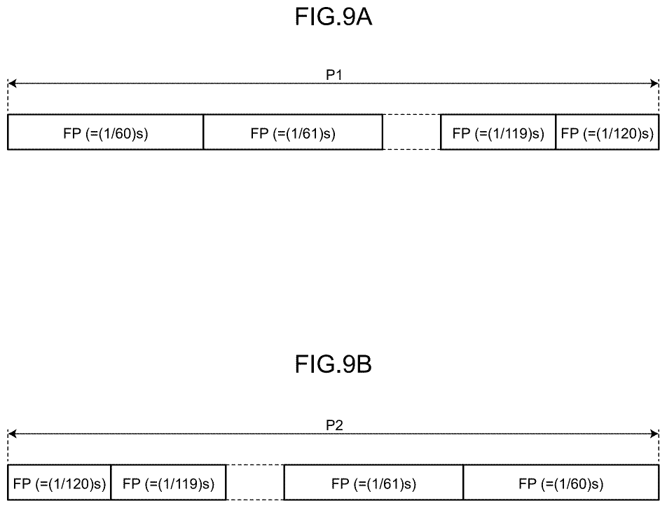

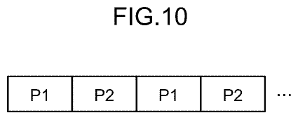

FIG. 9A is a first conceptual diagram illustrating a second specific example of the frame rate change in the display device. FIG. 9B is a second conceptual diagram illustrating the second specific example of the frame rate change in the display device. FIG. 10 is a third conceptual diagram illustrating the second specific example of the frame rate change in the display device.

In the second specific example illustrated in FIGS. 9A, 9B, and 10, the display device 100 repeats a first period P1 in which the display frame rate changes stepwise (for example, in steps of 1 fps) from the first frame rate (for example, 60 fps) to the second frame rate (for example, 120 fps) and a second period P2 in which the display frame rate is changed stepwise (in this case, in steps of 1 fps) from the second frame rate (in this case, 120 fps) to the first frame rate (in this case, 60 fps). As a result, when the display frame rate is 96 fps, the balance among the sub-field periods RF, GF, and BF included in the period while the shutter of the imaging device 300 is open ( 1/48 s) does not become uneven, and the display image of the display device 100 captured in the imaging frame of the imaging device 300 is not colored. Thus, the display image of the display device 100 can be captured without coloration.

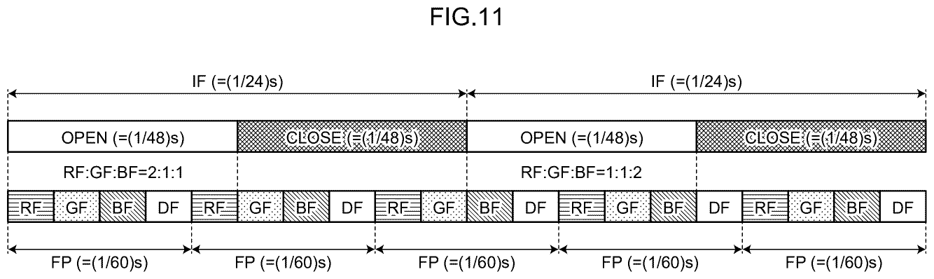

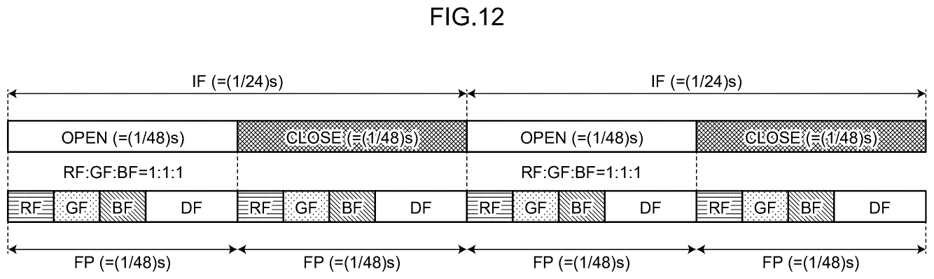

FIG. 11 is a diagram illustrating a third example of the imaging timing in the imaging device and the display timing in the display device. FIG. 12 is a diagram illustrating a fourth example of the imaging timing in the imaging device and the display timing in the display device.

The third example illustrated in FIG. 11 and the fourth example illustrated in FIG. 12 illustrate an aspect in which the one-frame period FP (=60 fps) includes a dummy field period DF in which no display is made.

The third example illustrated in FIG. 11 illustrates an example in which the display frame rate is 60 fps. In this case, the balance among the sub-field periods RF, GF, and BF included in the period while the shutter of the imaging device 300 is open ( 1/48 s) is uneven (for example, RF:GF:BF=2:1:1 or RF:GF:BF=1:1:2 in the example illustrated in FIG. 11), and the display image of the display device 100 captured in each imaging frame of the imaging device 300 is colored.

The fourth example illustrated in FIG. 12 illustrates an example in which the display frame rate is 48 fps. In this case, the balance among the sub-field periods RF, GF, and BF included in the period while the shutter of the imaging device 300 is open ( 1/48 s) is not uneven (RF:GF:BF=1:1:1 as illustrated in FIG. 12), and the display image of the display device 100 captured in each imaging frame of the imaging device 300 is not colored.

As illustrated in the third example illustrated in FIG. 11 and the fourth example illustrated in FIG. 12, in the aspect in which the one-frame period FP (=60 fps) includes the dummy field period DF in which no display is made, the frame rate can be changed by changing the length of the dummy field period DF without changing the length of each of the sub-field periods RF, GF, and BF. Thus, the display image of the display device 100 can be captured without coloration.

### Second Embodiment

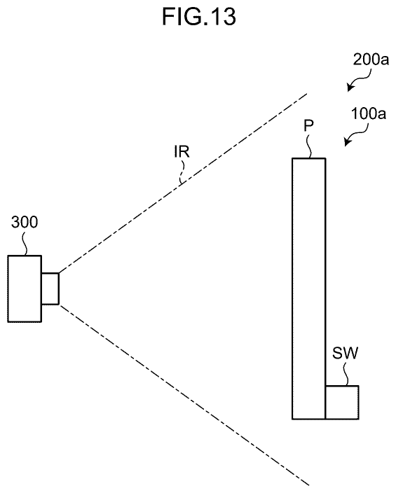

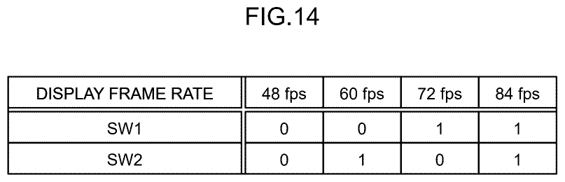

FIG. 13 is a diagram illustrating a schematic configuration of a display system according to a second embodiment of the present disclosure. FIG. 14 is a conceptual diagram illustrating a third specific example of the frame rate change in a display device. In a display system 200a according to the second embodiment illustrated in FIG. 13, a display device 100a includes a switch SW configured to change the display frame rate.

As the switch SW, a component, such as a dual in-line package (DIP) switch, that allows a plurality of settings in binary code is exemplified. The switch SW is not limited to a physical switch configured as hardware such as the DIP switch, and may be, for example, a programmable logic device (PLD) such as a field-programmable gate array (FPGA) or a software switch implemented by a microcontroller unit (MCU).

FIG. 14 illustrates an example of the DIP switch that has a two-circuit configuration as the switch SW. In the example illustrated in FIG. 14, one of 48 fps, 60 fps, 72 fps, and 84 fps can be selected as the display frame rate by combining “0” and “1” states of SW1 with “0” and “1” states of SW2.

In the example illustrated in FIG. 14, selecting 48 fps as the display frame rate prevents the display image of the display device 100a captured in each imaging frame of the imaging device 300 from being colored, without losing the balance among the sub-field periods RF, GF, and BF included in the period while the shutter of the imaging device 300 is open ( 1/48 s). Thus, the display image of the display device 100a can be captured without coloration.

While the preferred embodiment has been described above, the present disclosure is not limited to such an embodiment. The content disclosed in the embodiment is merely an example, and can be variously modified within the scope not departing from the gist of the present disclosure. Any modifications appropriately made within the scope not departing from the gist of the present disclosure also naturally belong to the technical scope of the present disclosure.

What is claimed is:

1. A display system comprising:
a display device comprising a display panel; and
an imaging device configured to capture an image of an imaging region in which at least the display panel is located, wherein
a one-frame period during which an image for one frame is displayed on the display panel includes a plurality of sub-field periods in which different colors are displayed, and
the display device is configured to be capable of changing a frame rate.

2. The display system according to claim 1, wherein the display device is configured to change the frame rate for each frame.

3. The display system according to claim 2, wherein the display device is configured to repeat a period in which the frame rate changes stepwise from a first frame rate to a second frame rate different from the first frame rate.

4. The display system according to claim 2, wherein the display device is configured to repeat a first period in which the frame rate changes stepwise from a first frame rate to a second frame rate different from the first frame rate and a second period in which the frame rate changes stepwise from the second frame rate to the first frame rate.

5. The display system according to claim 1, wherein display device comprises a switch configured to change the frame rate.

6. The display system according to claim 1, wherein
the sub-field periods comprise:
a first sub-field period to display a first color;
a second sub-field period to display a second color different from the first color; and
a third sub-field period to display a third color different from the first color and the second color.

7. The display system according to claim 6, wherein
the first frame period comprises a dummy field period in which no display is made, and
the display device is configured to change the frame rate by changing a length of the dummy field period.

8. The display system according to claim 1, wherein the display panel is a liquid crystal panel enclosing polymer-dispersed liquid crystals.

9. The display system according to claim 1, wherein the display device is a transparent display device configured to allow an image transmitted through the display panel to be viewed.
